(19) United States
(12) Patent Application Publication
(10) Pub. No.: US 2011/0186038 A1
(43) Pub. Date: Aug. 4, 2011

(54) Burner And Gas Oven Including The Same

(75) Inventors: Yang-Ho Kim, Changwon-si (KR); Jung-Wan Ryu, Changwon-si (KR); Dae-Bong Yang, Changwon-si (KR); Yong-Ki Jeong, Changwon-si (KR); Jae-Bum Lim, Changwon-si (KR); Young-Soo Kim, Changwon-si (KR); Dae-Rae Lee, Changwon-si (KR); Jea-Hyuk Wie, Changwon-si (KR); Jun-Ho Seok, Changwon-si (KR)

(73) Assignee: LG Electronics Inc., Seoul (KR)

(21) Appl. No.: 13/056,584

(22) PCT Filed: Jul. 28, 2009
(86) PCT No.: PCT/KR2009/004199

§ 371 Date: Apr. 21, 2011

(30) Foreign Application Priority Data
Aug. 1, 2008 (KR) 10-2008-0075773
Aug. 1, 2008 (KR) 10-2008-0075779
Apr. 17, 2009 (KR) 10-2009-0033883
Apr. 17, 2009 (KR) 10-2009-0033887

(51) Int. Cl. F24C 3/08; A21B 1/02

(52) U.S. Cl. 126/39 R

(57) ABSTRACT

A burner and a gas oven including the burner are provided. Food placed in an oven chamber is heated and cooked by using a burner disposed at an upper side of the oven chamber and having a fork or grating shape. Therefore, the food can be heated more uniformly.

### TECHNICAL FIELD

The present disclosure relates to a cooking device, and more particularly, to a burner configured to combust gas for cooking food and a gas oven including the burner.

### BACKGROUND ART

Gas ovens are used for cooking foods using a gaseous fuel. Such a gas oven includes an oven chamber in which food is cooked, and a burner configured to burn a gaseous fuel for cooking food accommodated in the oven chamber. The burner can be installed on the ceiling of the oven chamber for generating a flame by burning a gaseous fuel and heat food placed in the oven chamber by radiant heat from the flame.

### DISCLOSURE OF INVENTION

### Technical Problem

However, in the related art, since the burner is disposed at a center portion of the ceiling of the oven chamber, food placed in the oven chamber may not be uniformly heated.

### Technical Solution

Embodiments provide a burner configured to heat food more uniformly and a gas oven including the burner.

In one embodiment, a burner includes: a flow passage through which gas flows, the flow passage having a fork or grating shape; and a plurality of flame holes formed in at least a portion of one side of the flow passage in a direction perpendicular to a direction of a gas flow, so as to allow gas or a mixture of gas and air to be burned at the flame holes.

In another embodiment, a burner includes: a supply part configured to supply gas; a distribution part configured to receive gas from the supply part; and a plurality of parallel combustion parts including a plurality of flame holes, which are formed in at least one side in a direction perpendicular to a gas flow direction for receiving gas from the distribution part and allowing combustion of the received gas.

In further another embodiment, a gas oven includes: an oven chamber in which food is cooked; and the burner of any one of claims 1 to 20, the burner being disposed at a side of the oven chamber for provide heat to the oven chamber for cooking the food.

The details of one or more embodiments are set forth in the accompanying drawings and the description below. Other features will be apparent from the description and drawings, and from the claims.

### BRIEF DESCRIPTION OF DRAWINGS

FIG. 1 is a perspective view illustrating a gas oven according to a first embodiment.

FIG. 2 is a plan view illustrating a burner disposed at an upper side of an oven chamber according to the first embodiment.

FIG. 3 is a vertical sectional view illustrating a main part of the burner according to the first embodiment.

FIG. 4 is a plan view illustrating a burner disposed at an upper side of an oven chamber of a gas oven according to a second embodiment.

FIG. 5 is a plan view illustrating a burner disposed at an upper side of an oven chamber of a gas oven according to a third embodiment.

### BEST MODE FOR CARRYING OUT THE INVENTION

Hereinafter, a gas oven will be explained in detail with reference to the accompanying drawings according to a first embodiment.

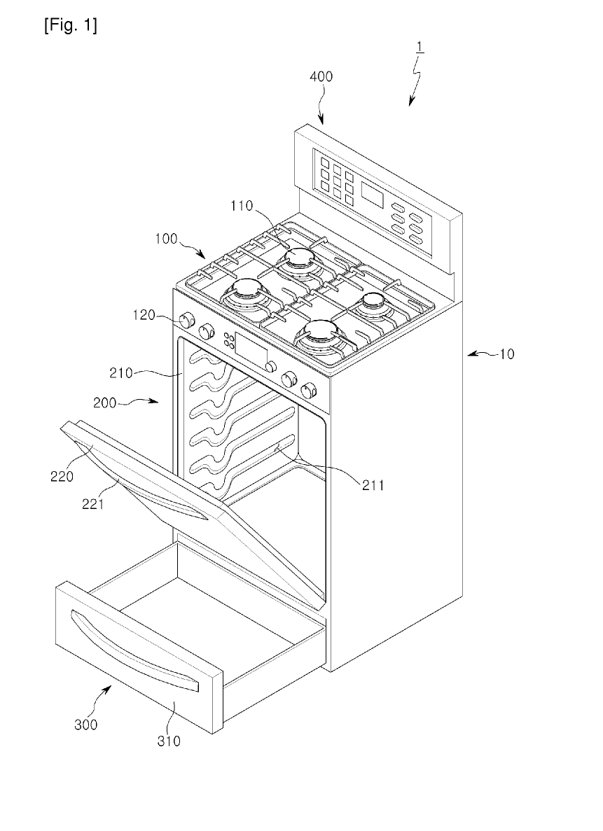

FIG. 1 is a perspective view illustrating a gas oven 1 according to a first embodiment;

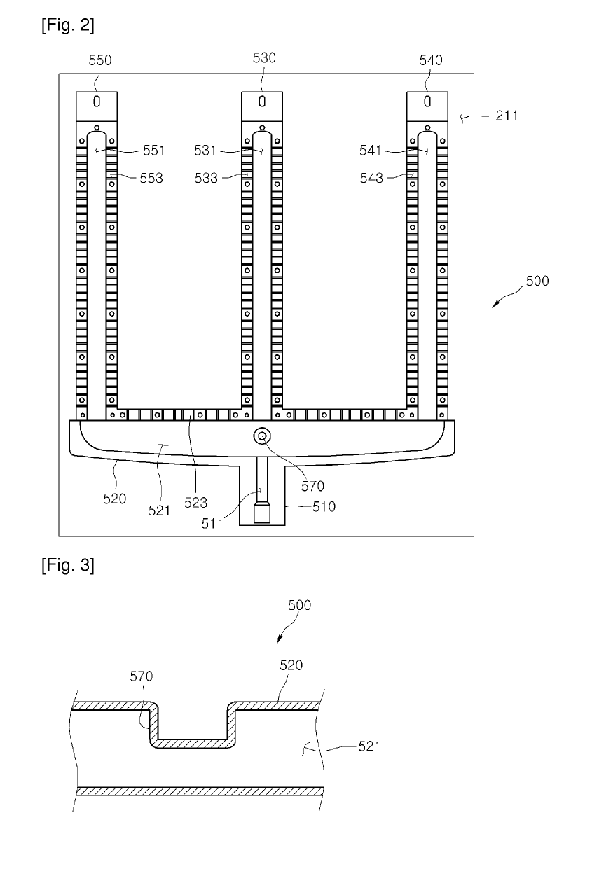

FIG. 2 is a plan view illustrating a burner 500 disposed at an upper side of an oven chamber 211 according to the first embodiment; and FIG. 3 is a vertical sectional view illustrating a main part of the burner 500 according to the first embodiment.

Referring to FIG. 1, the oven range 1 includes a cook top part 100, an oven part 200, a drawer part 300, and a control part 400. The cook top part 100, the oven part 200, and the drawer part 300 are disposed at upper, middle, and lower regions of a main body 10 of the oven range 1, respectively. The control part 400 is disposed on the top of the main body 10 at a rear edge portion corresponding to a rear side of the cook top part 100.

In more detail, the cook top part 100 includes a plurality of cook-top burners 110. Each of the cook-top burners 110 can generate a flame by burning a gaseous fuel to directly heat a container in which food is placed. A plurality of knobs 120 are disposed on a front end portion of the cook top part 100. The knobs 120 are used to close, open, or adjust valves (not shown) for starting, stopping, or adjusting supply of a gaseous fuel to the cook-top burners 110.

The oven part 200 includes an oven cavity 210 provided inside the main body 10. An oven chamber 211 and a burner chamber (not shown) are provided in the oven cavity 210. In the oven chamber 211, food is cooked, and in the burner chamber, a lower burner (not shown) is disposed for heating the food placed in the oven chamber 211 by convectional heat.

The oven chamber 211 can be selectively closed and opened by using an oven door 220. The oven door 220 is a pull-down door of which the top end can be rotated up and down about the lower end. A door handle 221 is provided on a front upper portion of the oven door 220 so that a user can easily rotate the oven door 220 using the door handle 221.

A container in which food is contained can be stored in the drawer part 300 at a predetermined temperature. The drawer part 300 includes a drawer 310 in which a container can be placed.

A manipulation signal can be input (generated) through the control part 400 for operating the oven range 1, specifically, at least one of the oven part 200 and the drawer part 300. In addition, the control part 400 displays information about operational conditions of the oven range 1.

Referring to FIGS. 2 and 3, the upper burner 500 is disposed at an upper side of the oven chamber 211. The upper burner 500 is used to burn a gaseous fuel to directly heat food placed in the oven chamber 211 by radiant heat. The upper burner 500 has a fork shape. The upper burner 500 includes a supply part 510, a distribution part 520, and three combustion parts 530, 540, and 550. The supply part 510, the distribution part 520, and the combustion parts 530, 540, and 550 may be formed in one piece.

In more detail, the supply part 510 is disposed at an upper rear part of the oven chamber 211 and has a shape elongated in a front-back direction. The supply part 510 functions as an inlet for receiving gas and air. A flow passage 511 is formed in the supply part 510. In the flow passage 511, gas and air are mixed.

The distribution part 520 extends from a front end of the supply part 510 toward left and right sides of the oven chamber 211. The distribution part 520 may be symmetric with respect to the supply part 510. The distribution part 520 includes a flow passage 521 connected to the flow passage 511 of the supply part 510. A gas mixture is transferred from the flow passage 511 of the supply part 510 to the flow passage 521 of the distribution part 520 where the gas mixture is distributed to the combustion parts 530, 540, and 550.

In the current embodiment, a plurality of flame holes 523 are formed in a front end of the distribution part 520. Some of a gas mixture flowing along the flow passage 521 of the distribution part 520 is burned at the flame holes 523. However, the flame holes 523 can be omitted.

The combustion parts 530, 540, and 550 extend from the front end of the distribution part 520 opposite to the supply part 510 in a front-back direction of the oven chamber 211. The combustion parts 530, 540, and 550 includes a first combustion part 530 extending from a center part of the distribution part 520 in the front-back direction of the oven chamber 211, a second combustion part 540 extending from a lateral end portion of the distribution part 520 in the front-back direction of the oven chamber 211, and a third combustion part 550 extending from the other lateral end portion of the distribution part 520 in the front-back direction of the oven chamber 211. Therefore, the first to third combustion parts 530, 540, and 550 are spaced from each other by a predetermined distance in the right-left direction of the oven chamber 211. The first combustion part 530 is substantially on the same line with the supply part 510. Flow passages 531, 541, and 551 are provided in the first to third combustion parts 530, 540, and 550, respectively, and are connected to the flow passage 521 of the distribution part 520. A gas mixture is transferred from the flow passage 521 of the distribution part 520 to the flow passages 531, 541, and 551 of the first to third combustion parts 530, 540, and 550. A plurality of flame holes 533, 543, and 553 are formed in both sides of the first to third combustion parts 530, 540, and 550. A gas mixture flowing along the flow passages 531, 541, and 551 of the first to third combustion parts 530, 540, and 550 is burned at the flame holes 533, 543, and 553.

A distribution guide 570 is disposed at a cross point of the supply part 510, the distribution part 520, and the first combustion part 530. In other words, the distribution guide 570 is disposed in the flow passage 521 of the distribution part 520 between the supply part 510 and the first combustion part 530. Owing to the distribution guide 570, a gas mixture flowing from the flow passage 511 of the supply part 510 to the flow passage 521 of the distribution part 520 can be uniformly distributed to the first to third combustion parts 530, 540, and 550. The distribution guide 570 may be a protrusion extending from the distribution part 520 into the flow passage 521. In the current embodiment, the distribution guide 570 has an approximate cylinder shape.

In more detail, the supply part 510 and the first combustion part 530 are placed along the same line. Therefore, most of a gas mixture transferred from the flow passage 511 of the supply part 510 to the flow passage 521 of the distribution part 520 may be distributed to the first combustion part 530. That is, the gas mixture flowing in the flow passage 521 of the distribution part 520 may not be uniformly distributed to the first to third combustion parts 530, 540, and 550. Therefore, in the current embodiment, the distribution guide 570 is provided so that a gas mixture supplied from the flow passage 511 of the supply part 510 to the flow passage 521 of the distribution part 520 is not mainly distributed to the first combustion part 530. That is, a gas mixture supplied from the flow passage 511 of the supply part 510 to the flow passage 521 of the distribution part 520 can be uniformly distributed to the first to third combustion parts 530, 540, and 550.

Hereinafter, operations of the gas oven 1 will be described in detail according to the first embodiment.

A user can input a manipulation signal by using the control part 400 for cooking food using the oven part 200. If a manipulation signal is input through the control part 400, the upper burner 500 (and the lower burner) is operated to cook food placed in the oven chamber 211.

In more detail, gas and air are supplied to the flow passage 511 of the supply part 510. The gas and air are mixed with each other as they flow along the flow passage 511 of the supply part 510.

Then, the gas mixture is transferred from the flow passage 511 of the supply part 510 to the flow passage 521 of the distribution part 520. Some of the gas mixture transferred to the flow passage 521 of the distribution part 520 is burned at the flame holes 523 of the distribution part 520 to form flames. The remaining gas mixture is transferred from the flow passage 521 of the distribution part 520 to the flow passages 531, 541, and 551 of the first to third combustion parts 530, 540, and 550.

At this time, owning to the distribution guide 570 provided in the flow passage 521 of the distribution part 520, the gas mixture is not mainly distributed to the flow passage 531 of the first combustion part 530 but uniformly distributed to the first to third combustion parts 530, 540, and 550. The gas mixture transferred to the flow passages 531, 541, and 551 of the first to third combustion parts 530, 540, and 550 is burned at the flame holes 533, 543, and 553 of the first to third combustion parts 530, 540, and 550 to form flames.

In this way, flames are formed by a gas mixture burned at the flame holes 523 of the distribution part 520 and the flame holes 533, 543, and 553 of the first to third combustion parts 530, 540, and 550, so that food placed in the oven chamber 211 can be heated by direct radiant heat. That is, food placed in the oven chamber 211 can be uniformly heated by the distribution part 520 and the first to third combustion parts 530, 540, and 550 (that is, by the upper burner 500), and thus cooking efficiency can be improved.

### MODE FOR THE INVENTION

Hereinafter, a gas oven will be explained in detail with reference to the accompanying drawing according to a second embodiment.

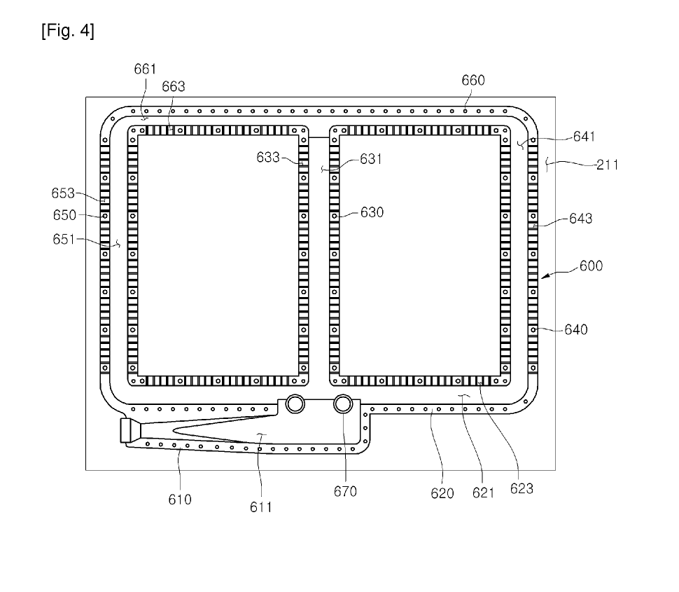

FIG. 4 is a plan view illustrating a burner disposed at an upper side of an oven chamber of a gas oven according to a second embodiment. In the current embodiment, the same elements as the first embodiment will be denoted by the reference numerals used in FIG. 1, and detailed descriptions thereof will be omitted.

Referring to FIG. 4, an upper burner 600, which is disposed at an upper side of the oven chamber 211, includes a supply part 610, a distribution part 620, a plurality of combustion parts 630, 640, and 650, and a connection part 660. The supply part 610, the distribution part 620, the combustion parts 630, 640, and 650, and the connection part 660 may be formed in one piece.

The supply part 610 transfers gas and air to the distribution part 620. A flow passage 611 is formed in the supply part 610. In the flow passage 611, gas and air are mixed. In the current embodiment, the supply part 610 extends from an upper rear side of the oven chamber 211 in a right-left direction of the oven chamber 211. Owing to this, the length of the supply part 610 may occupy less space in the oven chamber 211 so that the length of the combustion parts 630, 640, and 650 where combustion of a gas mixture is substantially performed can be increased for heating food efficiently. Gas and air supplied to an end of the supply part 610 are mixed with each other as they flow through the flow passage 611 of the supply part 610, and then the generates mixture is supplied to the distribution part 620 through the other end of the supply part 610.

The distribution part 620 transfers the gas mixture to the combustion parts 630, 640, and 650. That is, the distribution part 620 distributes a gas mixture received from the supply part 610 to the combustion parts 630, 640, and 650. The distribution part 620 extends in the right-left direction of the oven chamber 211, and the other end of the supply part 610 is connected to a center part of the distribution part 620.

The combustion parts 630, 640, and 650 includes a first combustion part 630 extending from the center part of the distribution part 620 in the front-back direction of the oven chamber 211, a second combustion part 640 extending from a lateral end portion of the distribution part 620 in the front-back direction of the oven chamber 211, and a third combustion part 650 extending from the other lateral end portion of the distribution part 620 in the front-back direction of the oven chamber 211. The first to third combustion parts 630, 640, and 650 include flow passages 631, 641, and 651, respectively, in which a gas mixture received from the distribution part 620 flows. The first to third combustion parts 630, 640, and 650 further include a plurality of flame holes 633, 643, and 653 where a gas mixture flowing along the flow passages 631, 641, and 651 is burned to form flames.

The connection part 660 connects front ends of the first to third combustion parts 630, 640, and 650. Therefore, the upper burner 600 can have a grating shape. The connection part 660 includes a flow passage 661 connected to the flow passages 631, 641, and 651 of the first to third combustion parts 630, 640, and 650. In the current embodiment, the connection part 660 includes a plurality of flame holes 663 for burning a gas mixture flowing in the flow passage 661 of the connection part 660.

Two distribution guides 670 are disposed at a part where the supply part 610 and the distribution part 620 are connected (that is, where the flow passage 611 of the supply part 610 is connected to the flow passage 621 of the distribution part 620). Owing to the distribution guides 670, a gas mixture supplied from the flow passage 611 of the supply part 610 to the distribution part 620 can be uniformly distributed to the first to third combustion parts 630, 640, and 650. In other words, owing to the two distribution guides 670, a gas mixture transferred to the distribution part 620 after flowing in the supply part 610 in a left-to-right direction of the oven chamber 211 is not mainly distributed to the flow passages 631 and 641 of the first and second distribution parts 630 and 640 but is uniformly distributed to the first to third combustion parts 630, 640, and 650. In the current embodiment, the two distribution guides 670 are disposed at an inner boundary part between the supply part 610 and the distribution part 620 which is close to a rear end of the first combustion part 630, and the distribution guides 670 are spaced apart from each other by a distance corresponding to the width of the first combustion part 630. Each of the distribution guides 670 has an approximate cylinder shape. The distribution guides 670 may be protrusions extending from the boundary part between the supply part 610 and the distribution part 620 toward the insides of the flow passages 611 and 621 of the supply part 610 and the distribution part 620.

Hereinafter, operations of the gas oven will be described in detail according to the second embodiment.

A user can input a manipulation signal by using the control part 400 (refer to FIG. 1) for using the oven part 200 (refer to FIG. 1). If a manipulation signal is input, the upper burner 600 (and the lower burner) is operated to cook food placed in the oven chamber 211.

When the upper burner 600 is operated, gas and air are supplied to the flow passage 611 of the supply part 610. The gas and air are mixed with each other as they flow along the flow passage 611 of the supply part 610, and then the gas mixture is transferred to the flow passage 621 of the distribution part 620. Thereafter, the gas mixture is distributed from the flow passage 621 of the distribution part 620 to the flow passages 631, 641, and 651 of the first to third combustion parts 630, 640, and 650.

At this time, owning to the distribution guides 670, when the gas mixture is transferred from the flow passage 621 of the distribution part 620 to the flow passages 631, 641, and 651 of the first to third combustion parts 630, 640, and 650, the gas mixture can be uniformly distributed. The gas mixture transferred to the flow passages 631, 641, and 651 of the first to third combustion parts 630, 640, and 650 is burned at the flame holes 633, 643, and 653 of the first to third combustion parts 630, 640, and 650 to form flames, so that food placed in the oven chamber 211 can be cooked by direct radiant heat.

Hereinafter, a gas oven will be described in detail with reference to the accompanying drawing according to a third embodiment.

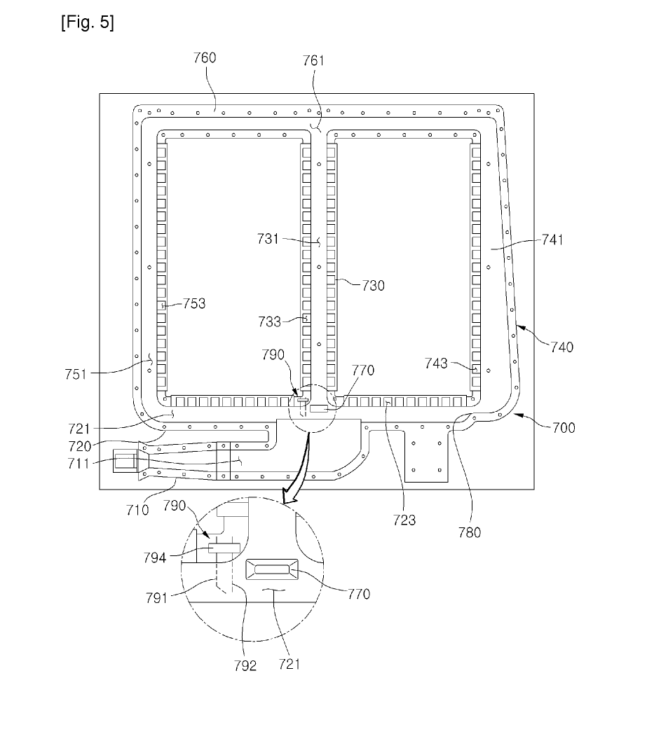

FIG. 5 is a plan view illustrating a burner disposed at an upper side of an oven chamber of a gas oven according to a third embodiment. In the current embodiment, the same elements as the first embodiment will be denoted by the reference numerals used in FIG. 1, and detailed descriptions thereof will be omitted.

Referring to FIG. 5, an upper burner 700, which is disposed at an upper side of the oven chamber 211, includes a supply part 710, a distribution part 720, a plurality of combustion parts (first to third combustion parts) 730, 740, and 750, and a connection part 760. The upper burner 700 has substantially the same structure as the upper burner 600 of the second embodiment.

In the current embodiment, the connection part 760 has no flame hole. A distribution guide 770 is provided to uniformly distribute a gas mixture to the first to third combustion parts 730, 740, and 750. The distribution guide 770 has a hexahedral shape with a width corresponding to the width of the first combustion part 730.

In the current embodiment, a neck part 780 is provided at a boundary part between the distribution part 720 and the second combustion part 740 for uniformly distributing a gas mixture to the first to third combustion parts 730, 740, and 750. In more detail, a relatively large amount of a gas mixture may be distributed to the second combustion part 740 as compared with the first and third combustion parts 730 and 750, because the second combustion part 740 is located at an end portion of the distribution part 720 which is spaced apart from the center portion of the distribution part 720 in a direction where the gas mixture flows in the supply part 710. To prevent this, in the current embodiment, the neck part 780 is provided at the boundary part between the distribution part 720 and the second combustion part 740.

The neck part 780 is formed by reducing the cross sectional area of the boundary part between the distribution part 720 and the second combustion part 740 as compared with the cross sectional areas of flow passages 721 and 741 of the distribution part 720 and the second combustion part 740. Therefore, a gas mixture flowing in the flow passage 721 of the distribution part 720 is not mainly distributed to the second combustion part 740 but is uniformly distributed to the first to third combustion parts 730 and 750.

Since the cross sectional area of the boundary part between the distribution part 720 and the second combustion part 740 is reduced due to the neck part 780, the velocity of a gas mixture increases at the boundary part. Therefore, a gas mixture transferred from the flow passage 721 of the distribution part 720 to the flow passage 741 of the second combustion part 740 may flow at an outer region of the flow passage 741 opposite to flame holes 743 of the second combustion part 740. In this case, the gas mixture may be not burned at some of the flame holes 743. To prevent this, in the current embodiment, the cross sectional area of the upstream side of the flow passage 741 of the second combustion part 740 close to the neck part 780 is increased relative to the cross sectional area of flow passages 731 and 751 of the first and third combustion parts 730 and 750. Therefore, the velocity of a gas mixture can be reduced at the upstream side of the flow passage 741 of the second combustion part 740, and thus the gas mixture can be uniformly burned at the flame holes 743 of the second combustion part 740. In addition, the cross sectional area of the flow passage 741 of the second combustion part 740 is decreased in a direction from the upstream side to the downstream side close to the connection part 760. Therefore, a gas mixture can be effectively burned at flame holes 743 of the second combustion part 740 located at the downstream side of the flow passage 741 where the flowrate of a gas mixture is relatively low.

The upper burner 700 includes a plug assembly 790 configured to generate a spark for igniting a gas mixture. In the current embodiment, a gas mixture is ignited at a position between the distribution part 720 and the second combustion part 740. The plug assembly 790 includes a spark plug 791, a plug target 792, and a plug holder 794.

A spark is generated between the spark plug 791 and the plug target 792 for igniting a gas mixture. The plug target 792 is formed of a metallic material and is spaced a predetermined distance from the spark plug 791. When power is applied to the spark plug 791, a spark is generated between the spark plug 791 and the plug target 792.

The spark plug 791 and the plug target 792 are installed in the plug holder 794. The plug holder 794 is fixed to a bracket (not shown) disposed at a lower side of the upper burner 700.

The spark plug 791 and the plug target 792 are horizontally placed. The spark plug 791 and the plug target 792 are substantially parallel with the first combustion part 730. Therefore, the plug assembly 790 does not largely increase the height of the upper burner 500.

The plug assembly 790 ignites a gas mixture to be discharged through flame holes 733 of the first combustion part 730. By a flame formed at the gas mixture to be discharged through the flame holes 733 of the first combustion part 730, a gas mixture to be discharged through flame holes 723 of the distribution part 720 is ignited. By a flame formed at the gas mixture to be discharged through the flame holes 723 of the distribution part 720, a gas mixture to be discharged through flame holes 743 and 753 of the second and third combustion parts 740 and 750 is ignited. In other words, a flame formed on a gas mixture ignited at the first combustion part 730 by the plug assembly 790 is propagated to the second and third combustion parts 740 and 750 through the distribution part 720.

Although embodiments have been described with reference to a number of illustrative embodiments thereof, it should be understood that numerous other modifications and embodiments can be devised by those skilled in the art that will fall within the spirit and scope of the principles of this disclosure.

### INDUSTRIAL APPLICABILITY

According to the present disclosure, food can be heated more uniformly.

As described above, according to the present disclosure, the burner and the gas oven including the burner provide the following effects.

According to the embodiments of the present disclosure, food placed in the oven chamber is heated by the burner disposed at the ceiling of the oven chamber and having a grate structure. In addition, flame holes are formed in both sides of the combustion part where gas is substantially burned. Therefore, food placed in the oven chamber can be heated more uniformly.

In addition, owing to the distribution guide, gas can be uniformly distributed to the combustion parts. Therefore, food can be uniformly cooked in the oven chamber.

1. A burner comprising:
a flow passage through which gas flows, the flow passage having a fork or grating shape; and
a plurality of flame holes formed in at least a portion of one side of the flow passage in a direction perpendicular to a direction of a gas flow, so as to allow gas or a mixture of gas and air to be burned at the flame holes.

2. The burner according to claim 1, further comprising a distribution protrusion such that gas or a mixture of gas and air supplied to one branch of the flow passage is uniformly distributed to other branches of the flow passage.

3. The burner according to claim 2, wherein the distribution protrusion is disposed at a position at which the flow passage is divided into two or more branches in different directions.

4. The burner according to claim 2, wherein the distribution protrusion is disposed inside the flow passage.

5. A burner comprising:
a supply part configured to supply gas;
a distribution part configured to receive gas from the supply part; and
a plurality of parallel combustion parts comprising a plurality of flame holes, which are formed in at least one side in a direction perpendicular to a gas flow direction for receiving gas from the distribution part and allowing combustion of the received gas.

6. The burner according to claim 5, wherein the combustion parts are disposed at an upper part of an oven chamber and elongated in a front-back or right-left direction.

7. The burner according to claim 5, wherein the distribution part is elongated in a right-left direction of an oven chamber, and the combustion parts branch off from the distribution part and extend in a front-back direction of the oven chamber.

8. The burner according to claim 7, further comprising a connection part configured to connect ends of the combustion parts branching off from the distribution part such that some of gas flowing in the combustion parts is transferred to the connecting part.

9. The burner according to claim 5, wherein the supply part extends in a front-back or right-left direction of an oven chamber,
the distribution part extends in the right-left direction of the oven chamber so as to be connected to an end of the supply part, and
the combustion parts branch off from the distribution part and extends in the front-back direction of the oven chamber.

10. The burner according to claim 5, wherein the supply part, the distribution part, and the combustion parts are formed in one piece.

11. The burner according to claim 5, further comprising a distribution protrusion enabling uniform distribution of gas from the distribution part to the combustion parts.

12. The burner according to claim 11, wherein one of the combustion parts is placed along a line in a direction in which gas is transferred from the supply part to the distribution part, and
the distribution protrusion is disposed at a position from which the one of the combustion parts branches off from the distribution part.

13. The burner according to claim 11, wherein the distribution protrusion is positioned in a flow passage along which gas is transferred from the supply part to the distribution part.

14. The burner according to claim 11, wherein the distribution protrusion is formed by protruding a portion of at least one of the distribution part and the combustion parts into a gas flow passage.

15. The burner according to claim 11, wherein if gas flows in a direction parallel with a direction in which gas is transferred from the supply part to the distribution part and is then distributed to the combustion part, the distribution protrusion disturbs the flow of the gas.

16. The burner according to claim 5, further comprising a neck part at a position from which one of the combustion parts branches off from the distribution part, the neck part having a cross sectional area smaller than a cross sectional area of the one of the combustion parts.

17. The burner according to claim 16, wherein the cross sectional area of the one of the combustion parts decreases from an upstream side to a downstream side of a gas flow.

18. The burner according to claim 16, wherein the supply part and the distribution part extend in parallel with each other,
the combustion parts extend in a direction perpendicular to the distribution part, and
the neck part is disposed at a position, from which the most downstream one of the combustion parts in a direction in which gas is transferred from the supply part to the distribution part is branched off from the distribution part.

19. The burner according to claim 5, further comprising a plug assembly configured to ignite gas at the combustion parts.

20. The burner according to claim 19, wherein the combustion parts comprise:
a first combustion part extending from a center portion of the distribution part in a front-back direction of an oven chamber;
a second combustion part extending from a lateral end portion of the distribution part in the front-back direction of the oven chamber; and
a third combustion part extending from the other lateral end portion of the distribution part in the front-back direction of the oven chamber,
wherein the plug assembly ignites gas to be discharged through the first combustion part to form a flame, and the flame propagates along the distribution part to gas to be discharged through the second combustion part and the third combustion part.

21. A gas oven comprising:
an oven chamber in which food is cooked; and
the burner of any one of claims 1 to 20, the burner being disposed at a side of the oven chamber for provide heat to the oven chamber for cooking the food.
